(19) United States
(12) Patent Application Publication
(10) Pub. No.: US 2026/0154495 A1
(43) Pub. Date: Jun. 4, 2026

(54) A METHOD FOR GENERATING A TEMPLATE AND RELATED ELECTRONIC DEVICE

(71) Applicant: MAERSK A/S, Copenhagen K (DK)

(72) Inventors: Goura Sundar MOHANTY, Bangalore (IN); Himanshu GAHLOT, Ghaziabad (IN); Anshuman Yajnavalkya PRADHAN, Angul Odisha (IN); Sunil Kumar CHINNAMGARI, Bangalore (IN)

(21) Appl. No.: 19/155,130

(22) PCT Filed: Jan. 11, 2024
(86) PCT No.: PCT/DK2024/050004

§ 371 Date: Aug. 8, 2025

(30) Foreign Application Priority Data
Feb. 10, 2023 (DK) PA202370075

(51) Int. Cl. G06F 16/28; G06F 16/355; G06F 16/93; G06F 40/284

(52) U.S. Cl. CPC G06F 40/186; G06F 16/35; G06F 40/295; G06F 40/30

(57) ABSTRACT

Disclosed is a method, performed by an electronic device, for generating a template for a conversational service. The method comprises obtaining textual data associated with an incoming communication. The method comprises generating, based on the textual data, one or more vectors indicative of a semantic representation of the textual data. The method comprises generating, based on the one or more vectors, a plurality of first clusters. The method comprises selecting, based on a purity parameter associated with each of the plurality of first clusters, one or more second clusters from the plurality of first clusters. The method comprises determining, for at least one second cluster, one or more extraction tokens based on the textual data associated with the at least one second cluster. The method comprises determining one or more categories of the one or more extraction tokens. The method comprises generating, based on the one or more vectors and the one or more categories, template data associated with one or more templates for the at least one second cluster. The method comprises providing template data for response to the incoming communication.

The present disclosure pertains to the field of textual data processing. The present disclosure relates to a method for generating a template and related electronic device.

### BACKGROUND

Organizations may deal with massive quantities of textual data obtained from several information sources and addressing multiple subjects in form of queries, audio files, and/or suggestions. The textual data may be obtained from conversational platforms, such as from one or more of: a chat, an electronic mail, an instant messaging, and any other suitable conversational platforms.

### SUMMARY

A template from such textual data may be beneficial to generate with such textual data. Manual handling of such textual data for generating a template can be prone to error, time consuming and not readily scalable.

Accordingly, there is a need for an electronic device and a method for generating a template, which mitigate, alleviate, or address the shortcomings existing and provide for a more efficient (e.g. standardised) response for an incoming communication.

Disclosed is a method, performed by an electronic device, for generating a template for a conversational service. The method comprises obtaining textual data associated with an incoming communication. The textual data includes a plurality of data elements. The method comprises generating, based on the textual data, one or more vectors indicative of a semantic representation of the textual data. The method comprises generating, based on the one or more vectors, a plurality of first clusters. The method comprises selecting, based on a purity parameter associated with each of the plurality of first clusters, one or more second clusters from the plurality of first clusters. The purity parameter is indicative of a similarity property of the plurality of data elements of a corresponding first cluster. The method comprises determining, for at least one second cluster, one or more extraction tokens based on the textual data associated with the at least one second cluster. The method comprises determining one or more categories of the one or more extraction tokens by applying an extraction technique to the one or more extraction tokens of the at least one second cluster. The method comprises generating, based on the one or more vectors and the one or more categories, template data associated with one or more templates for the at least one second cluster. The template data comprises a first part based on the semantic representation of the textual data and a second part representative of the one or more categories of the one or more extraction tokens. The method comprises providing template data for response to the incoming communication.

Disclosed is an electronic device comprising memory circuitry, processor circuitry, and an interface. The electronic device is configured to perform any of the methods disclosed herein.

Disclosed is a computer readable storage medium storing one or more programs, the one or more programs comprising instructions, which when executed by an electronic device cause the electronic device to perform any of the methods disclosed herein.

It is an advantage of the present disclosure that the disclosed electronic device and method enable generation of a template in a robust, accurate and scalable manner. The disclosed electronic device and method may allow analysing large collections of textual data and generating, based on such large collections of textual data, a template adapted to a specific subject.

The disclosed electronic device and method may be particularly advantageous for conversational services. In other words, the disclosed electronic device and method may enable an entity (e.g., a responder) to generate a template upon receiving an incoming communication, in which the template is generated based on the textual data associated with the incoming communication.

The disclosed electronic device and method may enable a reduction in errors (e.g., grammatical errors, word usage errors) as well as an increase in consistency and efficiency by providing a tailored structure for response to an incoming communication.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating schematically an example process for generating a template according to this disclosure,

FIG. 2 illustrates a representation of an example plurality of first clusters according to this disclosure,

FIG. 3 illustrates a representation of an example textual data and an example template according to this disclosure,

FIGS. 4A-4B illustrate a flow-chart illustrating an exemplary method, performed by an electronic device, for generating a template according to this disclosure, and

FIG. 5 is a block diagram illustrating an exemplary electronic device according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

A conversational service disclosed herein may be seen a conversational platform that allows communication between at least two entities (e.g., two devices, two systems, and/or two users). An incoming communication disclosed herein may be seen as a communication received at a first entity from a second entity, e.g. via a conversational service. A conversational service may be one or more of: an electronic mail, a chat, a chatbot, an instant messaging, and any other suitable conversational service. An incoming communication may encompass communication of textual data, which may be transmitted in form of an electronic mail, a message, an audio file (e.g., a call and/or an audio recording) and/or textual documentation (e.g., attachments associated with an incoming electronic mail).

Textual data disclosed herein may be seen as a body (e.g., corpus) of one or more of: a message associated with an electronic email, a chat conversation, a transcript of an audio file (e.g., from a video and/or an audio call), and textual documentation. The textual data may be associated with one or more conversational services, such as a same and/or a distinct conversational service. For example, the textual data may be obtained from an electronic mail platform and associated with one or more emails. Textual data may comprise a plurality of data elements (e.g., data points). For example, textual data may be obtained from one or more electronic emails. The textual data associated with each of the one or more electronic mails may be seen as a data element. The one or more electronic emails (e.g., one or more data elements) may address distinct and/or similar subjects.

The disclosed technique may enable generation of template data by extracting, from the textual data (e.g., body/corpus), data which either follows or not a specific format. For example, the disclosed technique can be useful for either predictive (e.g., tasks resulting from communications with a clear structure) or prescriptive analytical tasks (e.g., tasks resulting from communications which do not follow a specific format, such as a recommendation). It may be appreciated that the disclosure allows generating a response based on the template data disclosed herein (e.g., a response to the incoming communication or other incoming communication addressing a similar matter).

The disclosed technique may provide for template generation from conversational data. The template data generated may be used for generating a response for multiple incoming communications addressing a similar subject. In other words, the generated template may be reused for multiple incoming communications as long as they are address a similar subject. The disclosed technique may enable continuous improvement on the generated template as new incoming communications addressing a same subject are received and analysed.

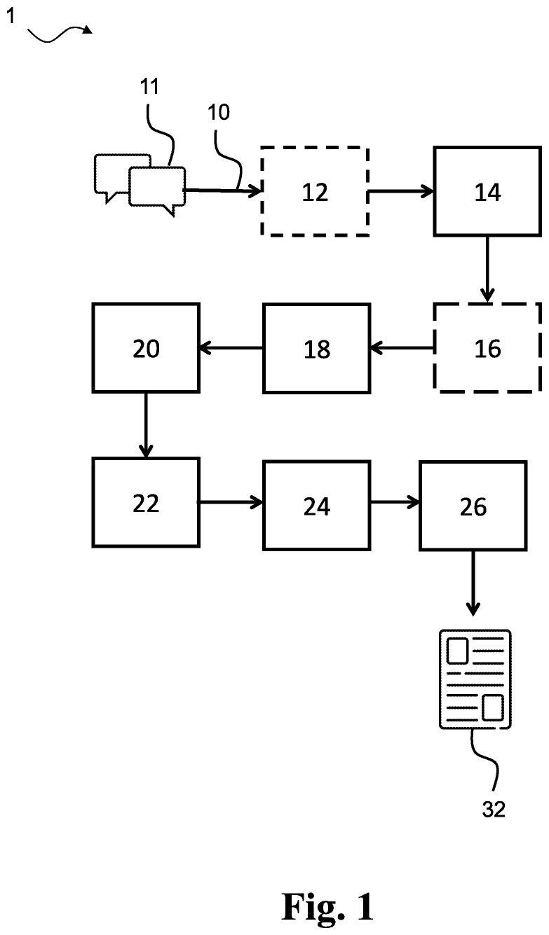

FIG. 1 is a diagram illustrating schematically an example process 1 for generating a template according to this disclosure. The process 1 is performed by the electronic device disclosed herein.

The electronic device obtains textual data 10 associated with an incoming communication 11. For example, the textual data 10 includes a plurality of data elements. Put differently, a data element may be seen as an element of the textual data. A data element may be representative of one or more tokens. For example, a token can be one or more of: a word, a string, a character, a number, and a punctuation mark. In some examples, a data element may be a document. The textual data 10 may be a body (e.g., corpus) associated with the incoming communication. For example, when the textual data 10 can obtained from an electronic mail, the textual data includes the body of such electronic mail.

The electronic device may pre-process in step 12 textual data 10, for example by removing the one or more specific tokens from the textual data 10 (e.g., from the plurality of data elements). The electronic device may remove one of more of: a stop token, a punctuation mark, a number, and a Uniform Resource Locator address, URL. The electronic device may remove a data element associated with less than five tokens (e.g., documents with less than five words). For example, data elements having a number of tokens (e.g., words and/or sentences) less than a threshold make not follow a specific format. In other words, the electronic device may disregard documents comprising a number of tokens below a threshold. The pre-processed textual data may be associated with a plurality of data elements. A data element from such plurality of data elements may be indicative of pre-processed textual data associated with one or more conversational services, with the pre-processed textual data addressing distinct and/or similar matters.

The electronic device generates in 14 one or more vectors (e.g. feature vectors) by, for example, applying a token embedding technique (e.g., an InferSent model) to the pre-processed textual data provided by 12. The electronic device may vectorize the pre-processed textual data by generating word embeddings associated such pre-processed textual data. In other words, the one or more vectors may indicate a semantic representation of the pre-processed textual data provided by 12. A semantic representation of the pre-processed textual data 12 may be seen as a meaning of the one or more tokens (e.g., comprised in the pre-processed textual data 12) intended by a user who sends the incoming communication.

The electronic device may generate the one or more vectors optionally by applying a dimension reduction technique 16 to the one or more vectors from 14. For example, dimension of a vector from 16 is lower than dimension of a corresponding vector provided by 14. For example, the dimension reduction technique can be seen as a manifold learning technique (e.g., a Uniform Manifold Approximation and Projection, UMAP, algorithm) for dimension reduction. For example, applying the dimension reduction technique to the one or more vectors of 14 is optionally performed after applying the InferSent model to the pre-processed textual data 12 (e.g., upon vectorizing the pre-processed textual data). The UMAP algorithm may reduce the dimension of a feature vector to a dimension reduction parameter without losing considerable amount of information. When the dimension reduction technique is not applied to the pre-processed textual data, the one or more vectors of 14 are provided to step 18.

The electronic device generates in 18 a plurality of first clusters by applying a multi-level clustering technique to the one or more vectors provided. For example, the electronic device may group (e.g., cluster) the pre-processed textual data (e.g., the plurality of data elements) into the plurality of first clusters based on one or more most frequent tokens in such pre-processed textual data. Put another way, the electronic device may assign the plurality of data elements associated with the pre-processed textual data with the one or more first clusters (e.g., performing cluster assignment) in step 16. The multi-level clustering technique may be based on a hierarchical density-based spatial clustering of applications with Noise, HDBSCAN, model.

The electronic device selects in step 20 one or more second clusters from the plurality of first clusters provided in 18. The electronic device selects the one or more second clusters based on a purity parameter associated with each of the plurality of first clusters. The purity parameter may indicate a similarity property of a plurality of data elements of a corresponding first cluster. Put differently, a first cluster may include a plurality of data elements (e.g., included in the textual data) with characteristics that may be similar for some data elements and may be distant for some other data elements. The purity parameter may measure how similar the plurality of data elements belonging to a first cluster are to each other. The electronic device identifies the one or more second clusters in 20 as one or more qualified clusters for performing template generation. For example, the qualified second clusters are cluster having a purity parameter meeting a first criterion. In other words, second clusters can be seen as clusters deemed sufficiently pure or holding sufficiently similar data elements.

The electronic device determines in step 22, for at least one second cluster, one or more extraction tokens based on the pre-processed textual data 12 (e.g., a plurality of data elements) associated with the at least one second cluster. The electronic device may determine the one or more extraction tokens of 22 based on a comparison between a first data element and a second data element of the plurality of data elements of the at least one second cluster. The first data element and the second data element may be associated with the textual data 10 (e.g., not with the pre-processed textual data of 12).

The electronic device may determine a distance (e.g., a token distance) for determining one or more mismatching tokens between the first data element and the second data element. Determining the one or more mismatching tokens may allow determining one or more distinguishing tokens between the first data element and the second data element, whose such data elements are associated with textual data 10. An extraction token may be seen as an uncommon token and/or a domain specific and/or a dissimilar token (e.g., keyword). Examples of extraction tokens include one or more: a date, a time, a name, an organization name, a country name, a user's name, a code, an identifier, a URL address, and an email.

The electronic device determines in step 24 one or more categories of the one or more extraction tokens. The electronic device may determine the one or more categories 24 by applying an extraction technique to the one or more extraction tokens of the at least one second cluster. For example, a category may be a category associated with one or more of: a date, a time, a name, an organization's name, a country's name, a user's name, a code, an identifier, a URL address, and an email identifier. For example, a category can be associated with a named and/or known entity such that an extraction token can be directly associated with a category. For example, an extraction token which is a date (e.g., 23/12/2022) may be categorized as a “date”. The extraction technique comprises one of more of: a Named Entity Recognition technique and a Regular Expression technique. The electronic device may replace the one or more extraction tokens of 22 with the one or more corresponding categories of 24 as placeholders in a response to the incoming communication.

The electronic device generates in step 26, based on the one or more vectors of 14 and the one or more categories of 24, template data. The template data may be associated with one or more templates for the at least one second cluster. For example, each of the one or more second clusters may be associated with generation of template data. For example, one or more second clusters may relate to textual data addressing different matters, which may lead to generation of distinct templates. The template data 26 comprises a first part based on the semantic representation of the textual data and a second part representative of the one or more categories of the one or more extraction tokens. The first part of the template data may relate to the one or more vectors of 14 which are generated based on the pre-processed textual data of 12. The second part of the template data may relate to the one or more categories from 24 which can replace the one or more extraction tokens determined in 22 (e.g., uncommon keywords).

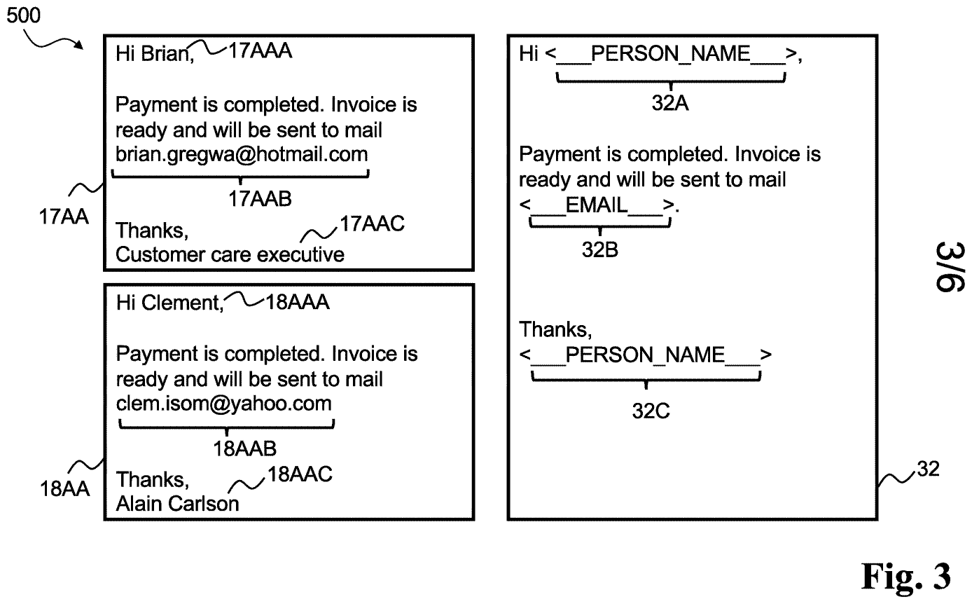

The electronic device provides the template data for response to the incoming communication. Put differently, the electronic device may generate, based on the template data, a template 32 (as illustrated in an example in FIG. 3).

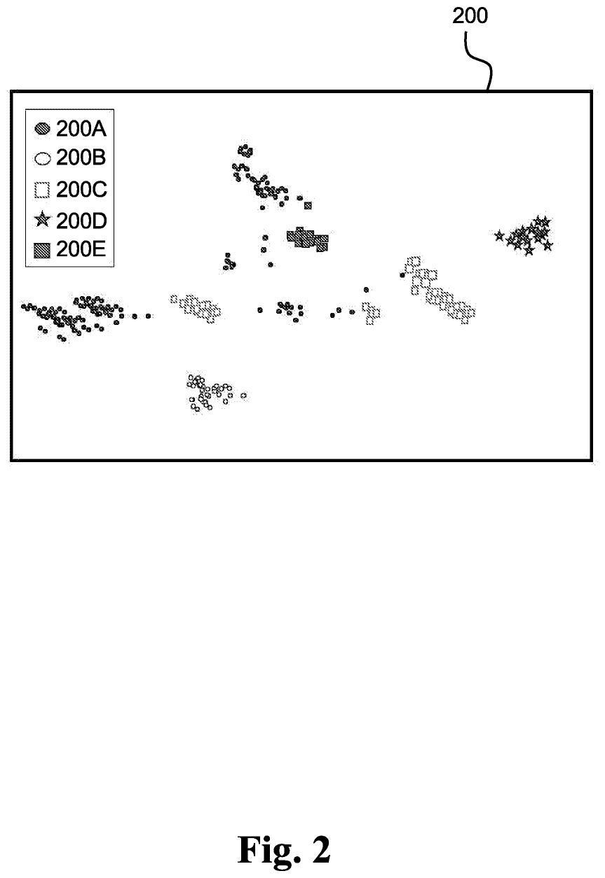

FIG. 2 is an example representation 200 of a plurality of first clusters according to this disclosure. Representation 200 shows a clustering result of a plurality of data elements (e.g., more than 500 data elements) for generation of the plurality of first clusters 200A, 200B, 200C, 200D, 200E (e.g., plurality of first clusters 18 of FIG. 1). Textual data associated with the plurality of data elements (e.g., textual data 10 of FIG. 1) may be pre-processed prior to performing the clustering process.

The plurality of first clusters 200A, 200B, 200C, 200D, 200E may be generated by applying a multi-level clustering technique to one or more vectors (e.g., one or more vectors 16 of FIG. 1). Representation 200 may be useful for identifying one or more second clusters (e.g., one or more second clusters 20), such as qualified dusters, for generating a template.

First clusters 200B, 200D, 200E may be seen as clusters having a purity parameter satisfying the first criterion, such as qualified clusters for generating template data. The first clusters 200B, 200D, 200E may be selected by the electronic device from the plurality of first clusters 200A, 200B, 200C, 200D, 200E. The first clusters 200B, 200D, 200E may be considered as one or more second clusters when selected for their purity parameter. In other words, the purity parameter of first clusters 200B, 200D, 200E shows that more than or equal to 80% of their respective data elements are mutually similar within each first cluster 200B, 200D, 200E. Put differently, a first cluster is pure when its purity parameter meets the first criterion, such as when the plurality of data elements associated with such first cluster belong to one quartile of similarities. For example, the mutual similarity of the plurality of data elements can be determined by applying a cosine similarity based technique to the plurality of data elements associated with the one or more second clusters 200B, 200D, 200E. First cluster 200C may be seen as having a purity parameter that does not meet the first criterion, such as clusters which is not qualified for generating a template. The first cluster 200C may not be included in the one or more second clusters. For example, less than 80% of the plurality of data elements are mutually similar within the first cluster 200C. The mutual similarity of the plurality of data elements for each first cluster 200B, 200C, 200D, 200E may be determined by analysing a similarity matrix associated with each of the first cluster 200B, 200C, 200D, 200E.

First cluster 200A may be seen as a sparse cluster which comprises a plurality of sparsely distributed data elements. Such plurality of sparsely distributed data elements may be seen as global outliners, such as data elements which do not belong to any cluster in specific, such as data elements which do not follow any specific template. The first cluster 200A may not be seen as a cluster and not selected to be part of the one or more second clusters.

Table 1A-1B illustrates the process of generating, based on a plurality of data elements comprised in a second cluster, template data, in which the second cluster is selected from one or more second clusters, such as from one or more second clusters 200, 200D, 200E of FIG. 2 and/or one or more second clusters 20 of FIG. 1. Table 1B shows a token length summary associated with information included in Table 1A.

TABLE 1

| | | | | Percentile |
|---|---|---|---|---|
| | | Pre- | | associated |
| Data | | processed | | with Token |
| element | | Textual | Token | Length = |
| Index | Textual Data | Data | Length | 75% |
| 1AA | Hi Anish, | payment | 8 | No |
| | Payment completed. | completed | | |
| | Invoice will be sent | invoice will | | |
| | to mail | be sent to | | |
| | anish@lorem.com. | mail | | |
| | Thanks, | | | |
| | Alex | | | |
| 2AA | Hi Amy, | payment | 8 | No |
| | Payment completed. | completed | | |
| | Invoice will be sent | invoice will | | |
| | to mail | be sent to | | |
| | amy@ipsum.com. | mail | | |
| | Thanks, | | | |
| | Alan | | | |
| 3AA | Hi Jacky, | payment | 8 | No |
| | Payment completed. | completed | | |
| | Invoice will be sent | invoice will | | |
| | to mail | be sent to | | |
| | jacky@amet.com | mail | | |
| | Thanks, | | | |
| | Alan | | | |
| 4AA | Hi Vis, | payment | 8 | No |
| | Payment completed. | completed | | |
| | Invoice will be sent | invoice will | | |
| | to mail | be sent to | | |
| | visk@accumsan.com. | mail | | |
| | Thanks, | | | |
| | Brion Asley | | | |
| 5AA | Hi Alex, | payment | 8 | No |
| | Payment completed. | completed | | |
| | Invoice will be sent | invoice will | | |
| | to mail | be sent to | | |
| | alex@auctor.com. | mail | | |
| | Thanks | | | |
| 6AA | Hi Jeremy, | payment | 8 | No |
| | Payment completed. | completed | | |
| | Invoice will be sent | invoice will | | |
| | to mail | be sent to | | |
| | jeremy@dolor.com | mail | | |
| | Thanks | | | |
| 7AA | Hi Customer, | payment | 8 | No |
| | Payment completed. | completed | | |
| | Invoice will be sent | invoice will | | |
| | to mail. | be sent to | | |
| | Thanks | mail | | |
| 8AA | Hi, | payment | 8 | No |
| | Payment completed. | completed | | |
| | Invoice will be sent | invoice will | | |
| | to mail. | be sent to | | |
| | Thanks | mail | | |
| 9AA | Hi Grahm, | payment | 8 | No |
| | Payment completed. | completed | | |
| | Invoice will be sent | invoice will | | |
| | to mail | be sent to | | |
| | grahm@adipiscing.com | mail | | |
| | Thanks, | | | |
| | Salem | | | |
| 10AA | Hi, | payment | 8 | No |
| | Payment completed. | completed | | |
| | Invoice will be sent | invoice will | | |
| | to mail. | be sent to | | |
| | Thanks | mail | | |
| 11AA | Hi, | payment | 8 | No |
| | Payment completed. | completed | | |
| | Invoice will be sent | invoice will | | |
| | to mail. | be sent to | | |
| | Thanks | mail | | |
| 12AA | Hi, | payment | 8 | No |
| | Payment completed. | completed | | |
| | Invoice will be sent | invoice will | | |
| | to mail. | be sent to | | |
| | Thanks | mail | | |
| 13AA | Hi, | payment | 8 | No |
| | Payment completed. | completed | | |
| | Invoice will be sent | invoice will | | |
| | to mail. | be sent to | | |
| | Thanks | mail | | |
| 14AA | Hi Trion, | payment is | 12 | Yes |
| | Payment is completed. | completed | | |
| | Invoice is ready and | invoice is | | |
| | will be sent to mail to | ready and | | |
| | bsec@vivamus.com | will be sent | | |
| | Thanks, | to mail | | |
| | Alain Carlson | | | |
| 15AA | Hi Brian, | payment is | 12 | Yes |
| | Payment is completed. | completed | | |
| | Invoice is ready and | invoice is | | |
| | will be sent to mail to | ready and | | |
| | brian@lectus.com | will be sent | | |
| | Thanks, | to mail | | |
| | Customer care executive | | | |
| 16AA | Hi Clement, | payment is | 12 | Yes |
| | Payment is completed. | completed | | |
| | Invoice is ready and | invoice is | | |
| | will be sent to mail to | ready and | | |
| | clem@euismod.com | will be sent | | |
| | Thanks, | to mail | | |
| | Alain | | | |
| 17AA | Hi Elisha, | payment is | 12 | Yes |
| | Payment is completed. | completed | | |
| | Invoice is ready and | invoice is | | |
| | will be sent to mail to | ready and | | |
| | elisha@tempor.com | will be sent | | |
| | Thanks, | to mail | | |
| | Alisa | | | |
| 18AA | Hi Customer, | payment is | 12 | Yes |
| | Payment is completed. | completed | | |
| | Invoice is ready and | invoice is | | |
| | will be sent to mail to | ready and | | |
| | rect@mattis.com | will be sent | | |
| | Thanks, | to mail | | |
| | Elena | | | |

| | |
|---|---|
| Mean | 9.1111 |
| Standard Deviation | 1.8435 |
| Minimum | 8.0 |
| 25% | 8.0 |
| 50% | 8.0 |
| 75% | 11.0 |
| Maximum | 12.0 |

For example, each data element of the plurality of data elements is associated with textual data (e.g., raw textual data, see Table 1A, column 2) and pre-processed textual data (e.g., see Table 1A, column 3). In such illustrative example, it is assumed that a second cluster from the one or more second clusters 200B, 200D, 200E comprises 18 data elements.

The electronic device may determine a first token length parameter (e.g., a token length, see Table 1A, column 4) indicative of a length of the pre-processed textual data. The electronic device may calculate the number of tokens associated with the pre-processed textual data.

The electronic device may convert the first token length parameter (e.g., associated with the plurality of data elements) into one or more percentiles for provision of a token length distribution (e.g., see Table 1B). In other words, the electronic device may distribute the length of the pre-processed textual data associated with each data element into one or more percentiles. The electronic device may select, based on the token length distribution, one or more data elements (e.g., data elements 14AA-18AA of Table 1A) from the plurality of data elements (e.g., data elements 1AA-18AA of Table 1A) whose first token length parameter belongs to 75th percentile (e.g., see Table 1A, column 5). Put differently, the electronic device may select one or more data elements from the plurality of data elements comprising more than or equal to 11 tokens (e.g., first token length parameter is greater than or equal to 11), as shown in Table 1B. For example, the electronic device selects a first data element 17AA and a second data element 18AA from the plurality of data elements 14AA-18AA (e.g., see Tables 1A, 1B). For example, any two data elements may be selected from the plurality of data elements. Selecting a first data element and a second data element may allow capturing maximum randomness within the second cluster to include as much information as possible in a template to be generate based on the textual data (e.g., raw textual data and/or pre-processed textual data) comprised in the first data element and the second data element. The first data element 17AA and the second data element 18AA may be seen as appropriate data elements from a qualified cluster (e.g., a second cluster) for generating a template.

It may be appreciated that when the disclosed technique is applied to 100K emails, and the template data generated according to this disclosure includes more than 200 templates and covers more than 30% of the entire email corpus.

FIG. 3 illustrates a representation 500 of example textual data (e.g., associated with one or more data elements, e.g., data elements 17AA, 18AA) and an example template 32 (e.g., which is generated based on the example textual data).

The template data for template 32 may be generated based on textual data (e.g., raw textual data) associated with first data element 17AA and second data element 18AA. In other words, the template data for template 32 may be generated by determining one or more extraction tokens (e.g., one or more extraction tokens 22 of FIG. 1). The electronic device may determine one or more extraction tokens (e.g., such as one or more extraction tokens 22 of FIG. 1) by determining a distance indicative of one or more mismatching tokens (e.g., one or more distinguishing tokens) between raw textual data (see Table 1A, column 2) associated with a first data element 17AA and the second data element 18AA.

For example, “@” of tokens 17AAB, 18AAB and tokens (e.g., signatures, names) 17AAA, 17AAC, 18AAA, 18AAC are extraction tokens determined by comparing the raw textual data associated with data element 17AA with the raw textual data associated with data element 18AA. The electronic device may determine one or more categories related to the one or more extraction tokens. The one or more categories may be determined by applying an extraction technique (e.g., NER and/or Regex techniques) to the one or more domain tokens.

For example, the one or more extraction tokens may be replaced by the one or more categories. For example, first tokens 17AAB, 18AAB may be replaced by second tokens 32B due to presence of extraction token “@”. Put differently, the first tokens 17AAB, 18AAB may be categorized and/or classified as an “email identifier” and replaced by a corresponding placeholder (e.g., <_EMAIL_>). For example, first tokens 17AAA, 17AAC, 18AAA, 18AAC may be replaced by second tokens 32A, 32C due to presence of a name (e.g., a signature, a name of a person). Put another way, the first tokens 17AAA, 17AAC, 18AAA, 18AAC may be categorized and/or classified as a “person name” and replaced by a corresponding placeholder (e.g., <_PERSON_NAME_>).

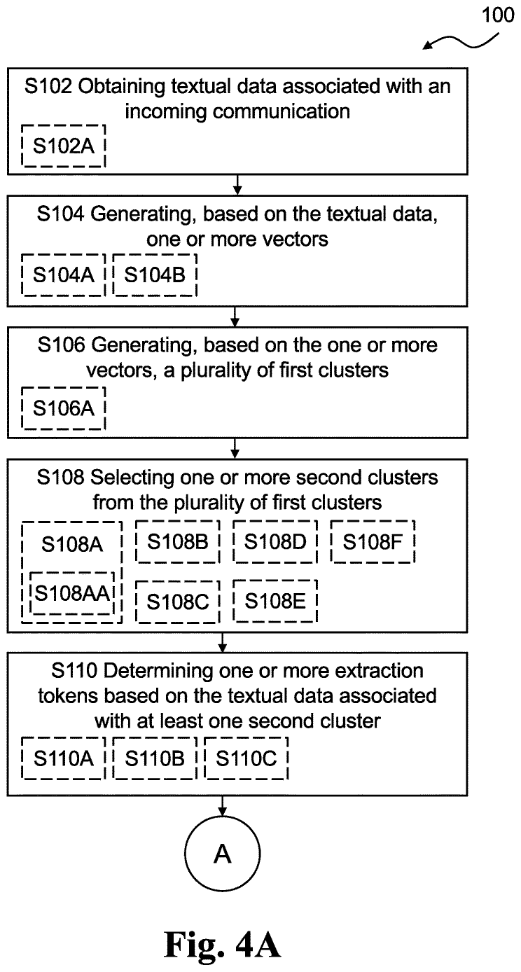

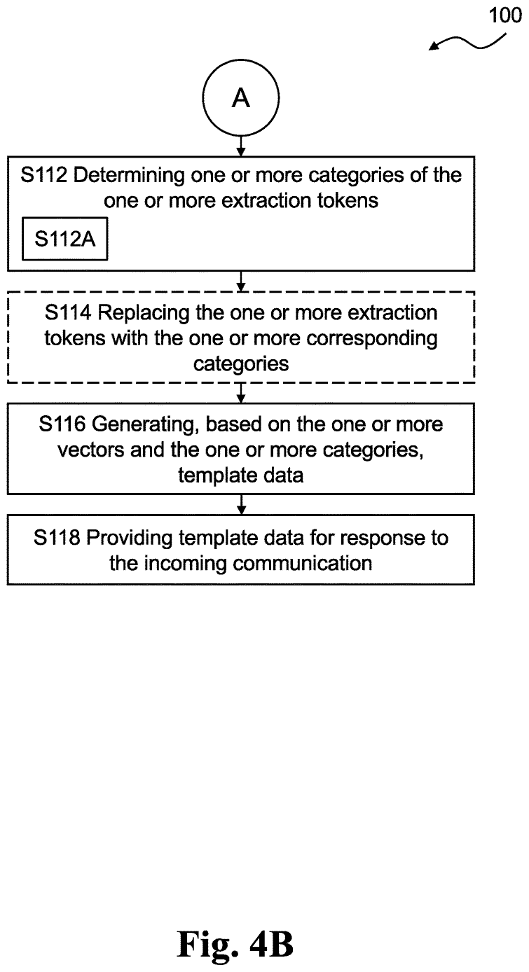

FIGS. 4A-4B illustrate a flow-chart of an exemplary method, performed by an electronic device, for generating template data, e.g. for generating a template for a conversational service according to the disclosure.

The method 100 comprises obtaining S102 textual data associated with an incoming communication. The obtaining S102 of the textual data may include receiving and/or retrieving the textual data. This is also illustrated in step 10 of FIG. 1. In some examples, the textual data includes a plurality of data elements. In one or more examples, an incoming communication may encompass communication of textual data, which may be transmitted in form of an electronic mail, a message, an audio file (e.g., a call and/or an audio recording) and/or textual documentation (e.g., attachments associated with an incoming electronic mail). In one or more examples, the textual data may be seen as a corpus and/or body of one or more of: an electronic email, a chat conversation, a transcript of an audio file, and textual documentation. For example, when the textual data is obtained from an electronic mail, the body of such electronic mail can be used to generate a template. For example, such electronic mail (e.g., a most recent electronic mail) is part of an electronic mail chain (e.g., with a common subject). It may be challenging to cluster and/or group such recent electronic mail when the electronic device obtains an entire electronic mail chain (e.g., body, header, footer, metadata) is used as textual data. A template may be generated based on a body associated a most recent email (e.g., associated a most recent time stamp) of an electronic mail chain to avoid high variance resulting from textual data included in header, footer of the entire electronic mail chain. The disclosed technique may enable generation of robust and reliable template data, while increasing time efficiency (e.g., by using a body associated with the incoming communication to generate template data).

In one or more examples, a data element is an element of the textual data. A data element can be associated with one or more tokens. For example, a token can be one or more of: a word, a string, a character, a number, and a punctuation mark.

In one or more examples, obtaining the textual data may comprise receiving and/or retrieving the textual data from a conversational service (e.g., an electronic mail, a chat, a chatbot, an instant messaging). In one or more examples, obtaining textual data comprises generating pre-processed textual data from a primary textual data. Textual data may be pre-processed textual data (e.g., textual data to be converted into one or more vectors) and/or raw textual data (e.g., textual data associated with data elements 17AA, 18AA of FIG. 3 and Table 1A,1B).

The method 100 comprises generating S104, based on the textual data, one or more vectors indicative of a semantic representation of the textual data. In one or more examples, the one or more vectors are generated by converting the textual into one or more vectors. Put differently, the textual data may be vectorized by the electronic device as illustrated in step 14 FIG. 1. In one or more examples, a semantic representation of the textual data encompasses a meaning of the one or more tokens (e.g., associated with the textual data) intended by a user who sends the incoming communication. In other words, the semantic representation of the textual data comprises a meaning of the one or more tokens which is generated based on context behind the incoming communication. In some examples, the one or more vectors may be associated with the textual data obtained from one or more data sources. The one or more tokens comprised in the textual data may be obtained from a same data source, but with different time stamps and some differences in terms of content. For example, the textual data may be obtained from one or more emails. The one or more emails may be similar in terms of content (e.g., they may not be completely equal) but not in terms of time stamp (e.g., the one or more emails may have been received at different times).

The method 100 comprises generating S106, based on the one or more vectors, a plurality of first clusters. This is also illustrated in step 18 of FIG. 1. In one or more examples, generating the plurality of first clusters comprises assigning the plurality of data elements associated with the respective vectors to the plurality of first clusters. For example, the one or more data elements of the plurality of data elements associated with the vectorized textual data can form one cluster of the one or more first clusters (e.g., cluster assignment).

The method 100 comprises selecting S108, based on a purity parameter associated with each of the plurality of first clusters, one or more second clusters from the plurality of first clusters. The selection S108 may be performed based on a purity parameter associated with at least one first cluster of the plurality. The purity parameter is indicative of a similarity property of the plurality of data elements of a corresponding first cluster. This is also illustrated in step 20 of FIG. 1. For example, a first cluster may be defined by a plurality of data elements (e.g., included in the textual data) with similar characteristics (e.g., addressing a similar subject). The purity parameter may measure how similar the plurality of data elements belonging to a first cluster are to each other. A second cluster may be generated based on such purity parameter. For example, a second cluster can be seen as a qualified cluster (e.g., pure cluster) for generating a template. The one or more second clusters may be less than the plurality of first clusters.

The method 100 comprises determining S110, for at least one second cluster, one or more extraction tokens based on the textual data associated with the at least one second cluster. An extraction token can be seen as a token used for the extraction, e.g. extraction of specific terms. In one or more examples, an extraction token (e.g., keyword) may be seen as one or more of: an uncommon token, a domain specific token, a dissimilar token, and a dynamic token. The extraction token can be seen as a keyword, such as an uncommon keyword. In one or more examples, determining the one or more extraction tokens comprises determining one or more distinguishing tokens between the textual data associated with one or more data elements of the least one second cluster. This may be illustrated in step 22 of FIG. 1.

The method 100 comprises determining S112 one or more categories of the one or more extraction tokens by applying S112A an extraction technique to the one or more extraction tokens of the at least one second cluster. This may be illustrated in step 24 of FIG. 1. In one or more examples, a category may be one or more of: a date, a time, a name, an organization's name, a country's name, a user's name, a code, an identifier, a URL address, a brand's name, and an email identifier. For example, a category can be associated with a named and/or known entity such that an extraction token can be associated with such named and/or known entity.

The method 100 comprises generating S116, based on the one or more vectors and the one or more categories, template data associated with one or more templates for the at least one second cluster. The template data comprises a first part based on the semantic representation of the textual data and a second part representative of the one or more categories of the one or more extraction tokens. This may be illustrated in step 26 of FIG. 1. In one or more examples, each of the one or more second clusters may be associated with generation of a template. For example, each of the one or more second clusters may relate to textual data addressing different matters, which may lead to generation of distinct templates. In one or more examples, the first part of the template data may relate to the one or more vectors which are generated based on the textual data (e.g., pre-processed and/or raw textual data). The second part of the template data may relate to the one or more categories which categorise and/or classify the one or more extraction tokens (e.g., uncommon keywords). The method 100 comprises providing S118 template data for response to the incoming communication.

It may be appreciated that in some example, one or more standardised responses can be associated with a plurality of incoming communications addressing similar subjects. Put differently, the disclosed electronic device and method may provide a standardised response with less deviation among other responses addressing a similar subject.

In some examples, where the response may lead to legal consequences, the disclosed electronic device and method may be particularly advantageous to generate a response which meets certain requirements, such as requirements of legal nature, allowing for efficient responses, and reducing liability.

In one or more example methods, selecting S108 the one or more second clusters comprises determining S108A the purity parameter associated with each of the first clusters. The purity parameter can be determined for each data element, such as for each pre-processed data element. In some examples, the purity parameter can be determined for at least one data element of at least one first cluster.

In one or more example methods, determining S108A the purity parameter comprises applying S108AA a clustering purity technique to the data elements of each of the first clusters. In one or more example methods, the clustering purity technique is based on a similarity measure. In one or more examples, the similarity measure includes one or more of: a cosine similarity measure, a Euclidean distance, and any other suitable similarity measure. The disclosed technique may benefit from the application of a cosine similarity measure to the data elements of each of the first cluster. For example, the cosine similarity measure measures purity of a first cluster based on angles between the data elements. Measuring purity of a first cluster based on such angles may enable accurate selection of the one or more second clusters.

In one or more example methods, selecting S108 the one or more second clusters comprises determining S108B similarity measures between each data element of each of the first clusters. In one or more examples, the similarity measures may be determined between at least two data elements of at least one first cluster, such as a part of and/or less than all data elements of each of the first clusters. In one or more examples, the similarity measures are determined by applying the cosine similarity measure to each data elements of at least one or each of the first clusters. In other words, the electronic device determines a cosine-similarity across the data elements of at least one or each of the first clusters. In other words, a cosine-similarity measure determines a mutual similarity between the plurality of data elements comprised in at least one or each of the first clusters. For example, the mutual similarity of the plurality of data elements for each first cluster may be determined by analysing a similarity matrix associated with each of the first cluster.

In one or more example methods, selecting S108 the one or more second clusters comprises converting S108C the similarity measures into one or more percentiles of each of the first clusters, e.g. into one or more quartiles of each of the first clusters. In one or more examples, converting the similarity measures into the one or more percentiles comprises obtaining, for each first cluster, a distribution related to the similarity measures. In one or more examples, converting the similarity measures into one or more percentiles comprises distributing, for each first cluster, the similarity measures associated with a mutual comparison of each data element into the one or more percentiles. In one or more examples, the electronic device can convert, for each first cluster, the similarity measures into one or more quartiles of each of the first clusters. In one or more example methods, selecting S108 the one or more second clusters comprises determining S108D, based on the similarity measures, the purity parameter for each percentile of the one or more percentiles of each of the first clusters. In one or more examples, the purity parameter for each percentile of the one or more percentiles can be calculated, per first cluster, by dividing the number of data element in a quartile with the number of data elements comprised in a first cluster.

In one or more example methods, selecting S108 the one or more second clusters comprises determining S108E, for each first cluster, whether the purity parameter meets a first criterion. In one or more example methods, selecting S108 the one or more second clusters comprises, upon the purity parameter associated with a respective first cluster meeting the first criterion, selecting S108F the respective first cluster as part of the one or more second clusters.

In one or more examples, the purity parameter associated with the respective first cluster meets the first criterion when the purity parameter is greater than or equal to a first threshold (e.g., >=80%). For example, the purity parameter associated with the respective first cluster meets the first criterion when a minimum of 80% of the plurality of data elements comprised in the respective first cluster are mutually similar. The respective first cluster may be pure when a minimum of 80% of the data elements comprised in the respective first cluster belong to one percentile (e.g., a quartile) of similarities. Put another way, the respective first cluster may be pure when max(purity parameter)≥80%. The respective first cluster may be included in the one or more second clusters. The respective first cluster may be seen as a qualified cluster for generating a template (e.g., first clusters 200B, 200D, 200E of FIG. 2).

For example, the method comprises disregarding one or more first clusters from the plurality of first clusters which are not selected to be part of the one or more second clusters. In one or more examples, selecting the one or more second clusters comprises, upon the purity parameter not meeting the first criterion, refraining from selecting the first cluster as part of the one or more second clusters. In one or more examples, the purity parameter associated with the respective first cluster does not meet the first criterion when the purity parameter is less than a first threshold (e.g., <80%). For example, less than 80% of the plurality of data elements are mutually similar within the respective first cluster. The respective first cluster may be seen as impure, such as a cluster which is not qualified for generating a template (e.g., first cluster 200C of FIG. 2) and not included in the one or more second clusters. In one or more examples, selecting the one or more second clusters comprises disregarding sparse first clusters, such as clusters comprising a plurality of sparsely distributed data elements. Such plurality of sparsely distributed data elements may be assigned as global outliners, such as data elements which do not belong to any cluster in specific, such as data elements which do not follow any specific template (e.g., first cluster 200A of FIG. 2).

In one or more example methods, determining S110 the one or more extraction tokens comprises determining the one or more extraction tokens based on a comparison of a first data element and a second data element of the at least one second cluster. For example, determining the one or more extraction tokens comprises comparing the first data element with the second data element of the at least one second cluster. In one or more example methods, determining S110 the one or more extraction tokens comprises determining S110A, for each token of the textual data associated with the at least one second cluster, a first token length parameter indicative of a length of a corresponding token. In one or more examples, determining the first token length parameter comprises determining a first token length parameter associated with each data element (e.g., some and/or less than all data elements) comprised in the at least one second cluster. Each data element (e.g., some and/or less than all data elements) may comprise one or more tokens associated with pre-processed textual data. The determination of the first token length parameter may be based on the pre-processed textual data. Put another way, the electronic device determines, for the at least one second cluster, a number of tokens comprised in each data element (e.g., some and/or less than all data elements) that is associated with pre-processed textual data (e.g., see Table 1A, column 3). In one or more examples, the electronic device may select, based on the first token length parameter, the first data element and the second data element. In one or more example methods, determining S110 the one or more extraction tokens comprises determining S110B whether the first token length parameter meets a second criterion. In one or more examples, determining whether the first token length parameter meets a second criterion comprises distributing (e.g., converting), for each of the plurality of data elements associated with the at least one second cluster, the first token length parameter into one or more percentiles (e.g., see Table 1B). In one or more example methods, the second criterion is based on a second threshold associated with a percentile distribution across the tokens. In one or more examples, the second criterion is based on a second threshold. For example, the token length parameter meets the second criterion when the token length parameter is greater than or equal to the second threshold (e.g., >=75th percentile or >=11 tokens). The second threshold may be indicative of a percentile where the token length parameter associated with each data element (e.g., some and/or less than all data elements), such as associated with pre-processed textual data, belongs to. The percentile where the token length parameter associated with each data element (e.g., some and/or less than all data elements) belongs to may be associated with a specific token length parameter. For example, comparing the first data element with the second data element of the at least one second cluster comprises selecting, based on the token length distribution, a first data element and a second data element whose first token length parameter belongs to 75th percentile (e.g., see Table 1A, column 5). In other words, comparing the first data element with the second data element of the at least one second cluster comprises selecting a first data element and a second data element that contain more than or equal to 11 tokens (e.g., first token length parameter is greater than or equal to 11), as shown in Table 1B. Selecting a first data element and a second data element whose token length parameter belongs to, for example, a 75th percentile may allow capturing randomness within the at least one second cluster to include satisfactory amount of information (e.g., neither much nor less quantity of information) in the template to be generated based on the textual data (e.g., raw textual data and/or pre-processed textual data) comprised in the first data element and the second data element. The disclosed technique may lead to a more reliable standardisation of a response for an incoming communication. In one or more examples, the first data element and the second data element may be seen as appropriate data elements from a qualified cluster (e.g., a second cluster) for generating a template.

In one or more example methods, determining S110 the one or more extraction tokens comprises, upon the first token length parameter meeting the second criterion, determining S110C a token mismatching parameter indicative of one or more mismatching tokens between the first data element and the second data element. In one or more examples, determining the token mismatching parameter comprises determining the token mismatching parameter based on the raw textual data associated with the first data element and the second data element. For example, a token mismatching parameter indicates one or more mismatching tokens between the first data element and the second data element. A mismatching token may be seen as one or more an uncommon token between the raw textual data associated with the first data element and the second data element. For example, a mismatching token may be associated with a specific context (e.g., “Denmark” may be perceived as a country).

In one or more example methods, determining S110 the one or more extraction tokens comprises determining S110D the one or more extraction tokens based on the token mismatching parameter. In one or more examples, the one or more extraction tokens are determined (e.g., by the electronic device) by determining a (e.g., token) distance between the raw textual data associated with the first data element and the second data element. In one or more examples, determining the one or more mismatching tokens comprise determining, based on raw textual data associated with the first data element and the second data element, one or more distinguishing tokens. An extraction token may be seen as a distinguishing and/or an uncommon and/or a domain specific and/or a dissimilar token.

In one or more example methods, the extraction technique comprises one of more of: a Named Entity Recognition, NER, technique and a Regular Expression, Regex, technique. In one or more examples, the one or more categories of the one or more extraction tokens can be determined by applying a NER and/or a Regex technique to the one or more extraction tokens of the at least one second cluster. In one or more examples, a NER technique can be seen as a technique which enables chunking and/or extraction and/or identification of the one or more categories of the one or more extraction tokens. The one or more extraction tokens may be seen as one or more entities, such as one or more tokens related to a specific context. The one or more extraction tokens may be classified into the one or more categories (e.g., predetermined and/or known categories). A Regex technique may identify and categorise the one or more extraction tokens with the one or categories in form of a pattern.

In one or more example methods, the method 100 comprises replacing S114 the one or more extraction tokens with the one or more corresponding categories. In one or more examples, replacing the one or more extraction tokens with the one or more corresponding tokens comprises replacing the one or more extraction tokens as placeholders. When an extraction token is a data, the extraction token may be replaced with “<_DATE_>”. When an extraction token is a time, the extraction token may be replaced with “<_TIME_>”. When an extraction token is an organization's name, the extraction token may be replaced with “<_ORG__>”. When an extraction token is a country's name, the extraction token may be replaced with “<_COUNTRY_>”. When an extraction token is a person's name, the extraction token may be replaced with “<_PERSON_NAME_>”. When an extraction token is a code with alphanumeric property, the extraction token may be replaced with “<__CODE__>”. When an extraction token is an identifier, ID, the extraction token may be replaced with “<_ID__>”. When an extraction token in a URL, the extraction token may be replaced with “<_URL__>”. When an extraction token in an email identifier, the extraction token may be replaced with “<_EMAIL_>”. The disclosed technique may enable identification of the one or more extraction tokens (e.g., one or more uncommon keywords) and mapping of such one or more extraction tokens (e.g., association of an extraction token with a category) to standardize a response for an incoming communication. The disclosed technique may enable accurate identification of one or more technical keywords (e.g., one or more extraction tokens) without the need of human resources (e.g., by applying NER and/or a Regex techniques to the one or more extraction tokens).

In one or more example methods, generating S106 the plurality of first clusters comprises applying S106A a multi-level clustering technique to the one or more vectors. In one or more example methods, the multi-level clustering technique comprises a hierarchical density-based clustering model. In one or more examples, the multi-level clustering technique can comprise one or more of: a density-based clustering model, a hierarchical-based model, and a distribution-based model. In one or more examples, the hierarchical density-based clustering model comprises a HDBSCAN model. For example, generating the plurality of first clusters by applying the HDBSCAN to the one or more vectors comprises generating the first cluster based on density of one or more most frequent tokens in the textual data.

In one or more example methods, the multi-level clustering technique may comprise a minimum size parameter and cluster selection parameter (e.g., associated with the first cluster). The minimum size parameter may be seen as a minimum number of data elements to be included in a first cluster for performing template generation. Put another way, a first cluster may be eligible to generate template data when the first cluster comprises, for example, at least 50 data elements. The minimum size parameter may be a positive integer value. The cluster selection parameter may allow merging one or more clusters, whose centroid of a cluster of the one or more clusters is at a distance less than or equal to the cluster selection parameter (e.g., 0.3 meters) in relation to a centroid of another cluster of the one or more clusters. Such merging procedure may allow generation of the plurality of first clusters. The minimum size parameter and the cluster selection parameter can be customisable.

In one or more example methods, generating S104 the one or more vectors comprises applying S104A a token embedding technique to the textual data. In one or more examples, the textual data (e.g., raw textual data and/or pre-processed textual data) is converted, by the electronic device, into one or more vectors by applying the token embedding technique to the textual data. In one or more examples, the token embedding technique comprises one or more of: an InferSent model, a Sentence-BERT model, a Doc2Vec model, and a Universal Sentence Encoding mode.

For example, the InferSent model converts textual data (e.g., raw textual data and/or pre-processed textual data) associated with each of the plurality of data elements into one or more corresponding vectors with size of 4096. By applying the InferSent model to the textual data, the electronic device may be able to convert textual data (e.g., associated with each of the plurality of data elements) which comprises a high number of tokens. The disclosed technique may allow analysing textual data (e.g., body and/or corpus) comprising a massive collection of tokens due to generation of vectors with higher dimensions (e.g., size). The disclosed technique may allow analysing higher variation of textual data (e.g., textual data with following different structures formats and comprising a high number of tokens).

In one or more example methods, generating S104 the one or more vectors comprises applying S104B a dimension reduction technique to the one or more vectors. In one or more examples, the dimension reduction technique can be seen as a manifold learning technique for dimension reduction. For example, the dimension reduction technique can comprise a UMAP algorithm. For example, applying the dimension reduction technique to the each of the one or more vectors comprises generating a low dimension representation of each of the one or more vectors. For example, applying the dimension reduction technique to each vector is optionally performed after applying the token embedding technique to textual data associated with a corresponding data element (e.g., upon vectorizing the textual data). For example, each vector can comprise one or more dimensions. For example, each vector can comprise a considerable number of dimensions. The UMAP algorithm may reduce the dimension of each vector (e.g., 4096) to a dimension reduction parameter (e.g., to 100) without loss of information. The dimension reduction parameter may be a positive integer value. The disclosed technique may allow minimizing likelihood of memory overload. The electronic device may not apply the UMAP to a vector of the one or more vectors when the textual data associated with the vector comprises a satisfactory (e.g., small) number of tokens.

In one or more example methods, obtaining S102 the textual data comprises pre-processing S102A the textual data for provision of pre-processed textual data (e.g., pre-processed textual data 10 of FIG. 1). In one or more examples, pre-processing the textual data comprises obtaining one or more tokens for removal. The one or more tokens are associated with a plurality of data elements. The one or more tokens may comprise one or more of: a stop token, a punctuation mark, a number, and a URL address. In one or more examples, pre-processing the textual data comprises determining a second token length parameter indicative of a length of the textual data (e.g., a number of tokens) associated with a plurality of data elements. In one or more examples, pre-processing the textual data comprises obtaining, based on the second token length parameter, one or more third data elements from the plurality of data elements for removal. In one or more examples, pre-processing the textual data comprises removing the one or more tokens and the one or more third data elements from the textual data (e.g., for provision the pre-processed textual data). In one or more examples, obtaining the one or more third data elements for removal comprises determining whether the second token length parameter meets a third criterion. In one or more examples, obtaining the one or more third data elements for removal comprises, upon the first token length parameter meeting the third criterion, selecting the one or more third data elements for removal. For example, the first token length parameter meets the third criterion when first token length parameter is less than five. Put differently, the electronic device may remove a data element that is associated with less than five tokens (e.g., words). For example, data elements associated with a small number of tokens (e.g., words and/or sentences) make not follow a specific format.

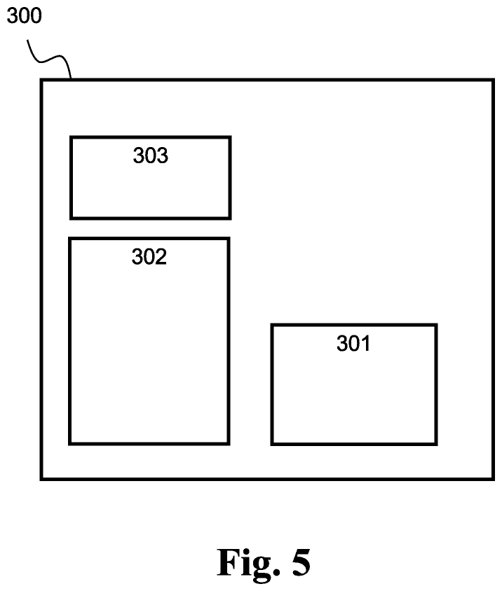

FIG. 5 shows a block diagram of an exemplary electronic device 300 according to the disclosure. The electronic device 300 comprises memory circuitry 301, processor circuitry 302, and an interface 303. The electronic device 300 is configured to perform any of the methods disclosed in FIGS. 4A-4B. In other words, the electronic device 300 is configured for generating template data for a template.

The electronic device 300 is configured to obtain (e.g., via the interface 303 and/or using the memory circuitry 301) textual data associated with an incoming communication. The textual data includes a plurality of data elements.

The electronic device 300 is configured to generate (e.g., using the processor circuitry 302), based on the textual data, one or more vectors indicative of a semantic representation of the textual data.

The electronic device 300 is configured to generate (e.g., using the processor circuitry 302), based on the one or more vectors, a plurality of first clusters.

The electronic device 300 is configured to select (e.g., using the processor circuitry 302), based on a purity parameter associated with each of the plurality of first clusters, one or more second clusters from the plurality of first clusters. The purity parameter is indicative of a similarity property of the plurality of data elements of a corresponding first cluster.

The electronic device 300 is configured to determine (e.g., using the processor circuitry 302), for at least one second cluster, one or more extraction tokens based on the textual data associated with the at least one second cluster.

The electronic device 300 is configured to determine (e.g., using the processor circuitry 302) one or more categories of the one or more extraction tokens by applying an extraction technique to the one or more extraction tokens of the at least one second cluster.

The electronic device 300 is configured to generate (e.g., using the processor circuitry 302), based on the one or more vectors and the one or more categories, template data associated with one or more templates for the at least one second cluster. The template data comprises a first part based on the semantic representation of the textual data and a second part representative of the one or more categories of the one or more extraction tokens.

The electronic device 300 is configured to provide (e.g., using the processor circuitry 302 and/or the interface 303) template data for response to the incoming communication.

The processor circuitry 302 is optionally configured to perform any of the operations disclosed in FIGS. 4A-4B (such as any one or more of: S102, S102A, S104, S104A, S104B, S106, S106A, S108, S108A, S108AA, S1081, S108C, S108D, S108E, S108F, S110, S110A, S110B, S110C, S112, S112A, S114, S116, S118). The operations of the electronic device 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the electronic device 300 may be considered a method that the electronic device 300 is configured to carry out. Also, while the described functions and operations may be implemented in software, such functionality may as well be carried out via dedicated hardware or firmware, or some combination of hardware, firmware and/or software.

The memory circuitry 301 may be one or more of: a buffer, a flash memory, a hard drive, a removable media, a volatile memory, a non-volatile memory, a random access memory (RAM), and any other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 5). The memory circuitry 301 is considered a non-transitory computer readable medium.

The memory circuitry 301 may be configured to store textual data, one or more vectors, a plurality of first clusters, one or more second clusters, a purity parameter, one or more extraction tokens, one or more categories, template data in a part of the memory.

Embodiments of methods and products (electronic device) according to the disclosure are set out in the following items:
Item 1. A method, performed by an electronic device, for generating a template for a conversational service, the method comprising:
   obtaining (S102) textual data associated with an incoming communication, wherein the textual data includes a plurality of data elements;
   generating (S104), based on the textual data, one or more vectors indicative of a semantic representation of the textual data;
   generating (S106), based on the one or more vectors, a plurality of first clusters;
   selecting (S108), based on a purity parameter associated with each of the plurality of first clusters, one or more second clusters from the plurality of first clusters, wherein the purity parameter is indicative of a similarity property of the plurality of data elements of a corresponding first cluster;
   determining (S110), for at least one second cluster, one or more extraction tokens based on the textual data associated with the at least one second cluster;
   determining (S112) one or more categories of the one or more extraction tokens by applying (S112A) an extraction technique to the one or more extraction tokens of the at least one second cluster;
   generating (S116), based on the one or more vectors and the one or more categories, template data associated with one or more templates for the at least one second cluster, wherein the template data comprises a first part based on the semantic representation of the textual data and a second part representative of the one or more categories of the one or more extraction tokens; and
   providing (S118) template data for response to the incoming communication.
Item 2. The method according to item 1, wherein selecting (S108) the one or more second clusters comprises determining (S108A) the purity parameter associated with each of the first clusters.
Item 3. The method according to item 2, wherein determining (S108A) the purity parameter comprises applying (S108AA) a clustering purity technique to the data elements of each of the first clusters, wherein the clustering purity technique is based on a similarity measure.
Item 4. The method according to any of the previous items, wherein selecting (S108) the one or more second clusters comprises:
   determining (S108B) similarity measures between each data element of each of the first clusters;
   converting (S108C) the similarity measures into one or more percentiles of each of the first clusters; and
   determining (S108D), based on the similarity measures, the purity parameter for each percentile of the one or more percentiles of each of the first clusters.
Item 5. The method according to any of the previous items, wherein selecting (S108) the one or more second clusters comprises determining (S108E), for each first cluster, whether the purity parameter meets a first criterion.
Item 6. The method according to item 5, wherein selecting (S108) the one or more second clusters comprises, upon the purity parameter associated with a respective first cluster meeting the first criterion, selecting (S108F) the respective first cluster as part of the one or more second clusters.
Item 7. The method according to any of the previous items, wherein determining (S110) the one or more extraction tokens comprises determining the one or more extraction tokens based on a comparison of a first data element and a second data element of the at least one second cluster.
Item 8. The method according to any of the previous items, wherein determining (S110) the one or more extraction tokens comprises:
   determining (S110A), for each token of the textual data associated with the at least one second cluster, a first token length parameter indicative of a length of a corresponding token; and
   determining (S110B) whether the first token length parameter meets a second criterion.
Item 9. The method according to item 8, wherein the second criterion is based on a second threshold associated with a percentile distribution across the tokens.
Item 10. The method according to items 8 and 9, wherein determining (S110) the one or more extraction tokens comprises, upon the first token length parameter meeting the second criterion, determining (S110C) a token mismatching parameter indicative of one or more mismatching tokens between the first data element and the second data element.
Item 11. The method according to item 10, wherein determining (S110) the one or more extraction tokens comprises determining (S110D) the one or more extraction tokens based on the token mismatching parameter.
Item 12. The method according to any of the previous items, wherein the extraction technique comprises one of more of: a Named Entity Recognition technique and a Regular Expression technique.
Item 13. The method according to any of the previous items, wherein the method comprises replacing (S114) the one or more extraction tokens with the one or more corresponding categories.
Item 14. The method according to any of the previous items, wherein generating (S106) the plurality of first clusters comprises applying (S106A) a multi-level clustering technique to the one or more vectors, wherein the multi-level clustering technique comprises a hierarchical density-based clustering model.
Item 15. The method according to any of the previous items, wherein generating (S104) the one or more vectors comprises applying (S104A) a token embedding technique to the textual data.
Item 16. The method according to any of the previous items, wherein generating (S104) the one or more vectors comprises applying (S104B) a dimension reduction technique to the one or more vectors.
Item 17. The method according to any of the previous items, wherein obtaining (S102) the textual data comprises pre-processing (S102A) the textual data.
Item 18. An electronic device comprising memory circuitry, processor circuitry, and an interface, wherein the electronic device is configured to perform any of the methods according to any of items 1-17.
Item 19. A computer readable storage medium storing one or more programs, the one or more programs comprising instructions, which when executed by an electronic device cause the electronic device to perform any of the methods of items 1-17.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that Figures comprise some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by an electronic device, for generating a template for a conversational service, the method comprising:
obtaining textual data associated with an incoming communication, wherein the textual data includes a plurality of data elements;
generating, based on the textual data, one or more vectors indicative of a semantic representation of the textual data;
generating, based on the one or more vectors, a plurality of first clusters;
selecting, based on a purity parameter associated with each of the plurality of first clusters, one or more second clusters from the plurality of first clusters, wherein the purity parameter is indicative of a similarity property of the plurality of data elements of a corresponding first cluster;
determining, for at least one second cluster, one or more extraction tokens based on the textual data associated with the at least one second cluster;
determining one or more categories of the one or more extraction tokens by applying an extraction technique to the one or more extraction tokens of the at least one second cluster;
generating, based on the one or more vectors and the one or more categories, template data associated with one or more templates for the at least one second cluster, wherein the template data comprises a first part based on the semantic representation of the textual data and a second part representative of the one or more categories of the one or more extraction tokens; and
providing template data for response to the incoming communication.

2. The method according to claim 1, wherein selecting the one or more second clusters comprises determining the purity parameter associated with each of the first clusters.

3. The method according to claim 2, wherein determining the purity parameter comprises applying a clustering purity technique to the data elements of each of the first clusters, wherein the clustering purity technique is based on a similarity measure.

4. The method according to claim 1, wherein selecting the one or more second clusters comprises:
determining similarity measures between each data element of each of the first clusters;
converting the similarity measures into one or more percentiles of each of the first clusters; and
determining, based on the similarity measures, the purity parameter for each percentile of the one or more percentiles of each of the first clusters.

5. The method according to claim 1, wherein selecting the one or more second clusters comprises determining, for each first cluster, whether the purity parameter meets a first criterion.

6. The method according to claim 5, wherein selecting the one or more second clusters comprises, upon the purity parameter associated with a respective first cluster meeting the first criterion, selecting the respective first cluster as part of the one or more second clusters.

7. The method according to claim 1, wherein determining the one or more extraction tokens comprises determining the one or more extraction tokens based on a comparison of a first data element and a second data element of the at least one second cluster.

8. The method according to claim 1, wherein determining the one or more extraction tokens comprises:
determining, for each token of the textual data associated with the at least one second cluster, a first token length parameter indicative of a length of a corresponding token; and
determining whether the first token length parameter meets a second criterion.

9. The method according to claim 1, wherein the extraction technique comprises one of more of: a Named Entity Recognition technique and a Regular Expression technique.

10. The method according to claim 1, wherein generating the plurality of first clusters comprises applying a multi-level clustering technique to the one or more vectors, wherein the multi-level clustering technique comprises a hierarchical density-based clustering model.
